(19) United States
(12) Patent Application Publication
(10) Pub. No.: US 2026/0044136 A1
(43) Pub. Date: Feb. 12, 2026

(54) Omniscient Anthropomorphic Data Intelligence System for Closed-Loop Real-Time Sensor-Edge Analytics in Drilling Operations and Industrial Facilities

(71) Applicant: BiaTech Corporation, Houston, TX (US)

(72) Inventors: Frederick H. GILLIS, Katy, TX (US); Nathaniel HARTWIG, Houston, TX (US)

(21) Appl. No.: 19/296,674

(22) Filed: Aug. 11, 2025

Related U.S. Application Data
(60) Provisional application No. 63/681,425, filed on Aug. 9, 2024.
(60) Provisional application No. 63/861,710, filed on Aug. 11, 2025.

(51) Int. Cl. G05B 19/418; E21B 21/08

(52) U.S. Cl. CPC G05B 19/4183; E21B 21/08; G05B 19/4184; G05B 19/41865

(57) ABSTRACT

An anthropomorphic AI control system including a plurality of sensors configured to collect industrial input data. The control system also includes an artificial intelligence-enabled edge-deployed computing device configured to analyze and fuse multimodal input data and generate an output through anthropomorphic computing. The computing device includes a cognitive module performing real-time decision-making at the sensor edge and a controller to manage industrial process actuators across operational domains. In management of industrial fluid flow, the control system may include AI-enabled fluid characterization modules to calculate the Reynolds number and incorporate compliance with AGA3 and AGA8 standards.

### CROSS-REFERENCE TO RELATED APPLICATIONS

The present application is related to U.S. Provisional Ser. No. 63/681,425 filed Aug. 9, 2024 entitled “Optimal Process Flow Heatmap,” and is related to U.S. Provisional Ser. No. 63/861,170 filed Aug. 11, 2025 entitled “Omniscient Anthropomorphic Data Intelligence System for Closed-Loop Real-Time Sensor-Edge Analytics and Control in Industrial Facilities.” The present application hereby claims priority under 35 U.S.C. § 119(e) to U.S. Provisional Ser. No. 63/681,425 and to U.S. Provisional Ser. No. 63/861,170. The above-identified provisional patent applications are hereby incorporated by reference in their entirety.

### TECHNICAL FIELD

The present disclosure relates in general to the field of industrial process automation systems, and more particularly to a novel data intelligence system for monitoring and controlling industrial equipment, as well as methods of use.

### BACKGROUND

Industrial equipment is burdened by siloed instrumentation, periodic human analysis, and delayed data feedback loops. In the case of oil and gas drilling rigs, conventional systems monitor drilling-fluid density and viscosity at the surface or within the borehole but often operate in isolated loops. For example, conventional systems often employ separate control systems for mud pumps, chemical dosing, solids-control units, shale shakers, and downhole sensors, forcing rig crews to rely on periodic manual sampling, lab analyses, and rule-of-thumb adjustments analysis to control drilling fluid properties such as density, viscosity, and compressibility. This fragmented approach prevents holistic optimization of drilling fluid properties and solids transport and introduces latency, leading to reactive rather than proactive adjustments, hindering responsiveness to fast-moving wellbore dynamics, driving up non-productive time, and inflating operational costs.

Furthermore, existing automation platforms for industrial equipment typically govern individual assets without integrating human-like perceptual filtering, contextual inferences, or predictive cognitive modeling. In the case of oil and gas drilling rigs, individual assets such as top drives, draw-works, or mud mixing systems are separately governed by automation platforms. For example, existing automation platforms often treat volumetric flow and compressibility as isolated variables and fail to integrate these parameters into holistic control routines. As a result, existing automation platforms cannot anticipate critical events such as sudden wellbore instability, circulating pressure surges, or lost-circulation zones, nor can they adapt fluid formulations on the fly to evolving downhole conditions. What is needed in the art is a unified, artificial intelligence (AI) driven control architecture deployed at the sensor edge of industrial facilities to monitor and control industrial facility operations.

### SUMMARY

Novel aspects of the present disclosure are directed to an anthropomorphic data intelligence control system including a plurality of sensors configured to collect industrial operation input data. The control system also includes an artificial intelligence-enabled computing device configured to analyze input data and generate an output through anthropomorphic computing. The computing device includes a cognitive module performing real-time decision-making at the sensor edge and a controller configured to manage industrial process actuators across operational domains.

In another embodiment, novel aspects of the disclosed principles are direct to a drilling fluid quality control system including a plurality of sensors configured to measure drilling fluid properties at the surface and within a borehole. The control system also includes actuators configured to modify system operation. The control system also includes an artificial intelligence-enabled computing device configured to analyze input data and generate an output through anthropomorphic computing, wherein the computing device comprises a memory storing input data, predefined thresholds, and artificial intelligence programming and a processing unit communicatively coupled to the memory and a controller. The processing unit is configured to process input data and generate a recommendation using artificial intelligence programming and the controller is configured to adjust actuator operation based on the recommendation.

In another embodiment, novel aspects of the disclosed principles are directed to a method for operating a fluid control system. The method comprises the steps of acquiring real-time sensor data including flow rate, fluid density, drill-string and borehole dimensions, and solids concentration; calculating a Reynolds number from the acquired data; inverting the Reynolds equation to determine inferred fluid parameters; analyzing fluid flow based on sensor data and inferred fluid parameters; issuing commands to one or more actuators to adjust fluid properties or flow rate; and recording the sensor data and actuator commands for iterative threshold refinement.

Other aspects, embodiments, and features of the disclosed principles will become apparent from the following detailed description when considered together with the accompanying figures. In the figures, each identical or substantially similar component that is illustrated in various figures is represented by a single numeral or notation. For the purposes of clarity, not every component is labeled in every figure. Nor is every component of each embodiment of the disclosed principles shown where illustration is not necessary to allow those of ordinary skill in the art to understand the principles disclosed herein.

### BRIEF DESCRIPTION OF THE DRAWINGS

The novel features believed characteristic of the disclosure are set forth in the appended claims. The disclosure itself, however, as well as a preferred mode of use, further objectives, and advantages thereof, will be best understood by reference to the following detailed description of illustrative embodiments when read in conjunction with the accompanying drawings, in which:

FIG. 1 is a schematic of an anthropomorphic AI control system in a drilling rig environment in accordance with the present disclosure;

FIG. 2 is a block diagram of the anthropomorphic AI control system of the present disclosure;

FIG. 3 is a schematic illustrating the data flow architecture of the control system in accordance with the present disclosure;

FIG. 4 is a schematic of an integrated supply chain management module in accordance with the disclosed principles;

FIG. 5 is flowchart illustrating a method for operating a control system in accordance with the present disclosure;

FIG. 6 is a flowchart illustrating a control sequence for use with a control system in accordance with the present disclosure.

### DETAILED DESCRIPTION

The present disclosure relates to systems and methods for automating and optimizing complex industrial processes, particularly in the management of multiphase fluid flow in the oil and gas sector. The present disclosure leverages edge-deployed AI-driven cognitive cores equipped with multi-modal data assimilation capabilities to process and contextualize real-time sensor inputs, historical datasets, and operational heuristics to enable autonomous classification of fluid regimes—laminar, transitional, or turbulent—without the need for dedicated rheometers or delay-prone laboratory interpretation. The AI-driven cores power the system's learning, reasoning, memory, and decision-making ability, allowing the system to understand live data, run simulations, think, and make decisions analogous to the human brain's cognitive abilities. Specific embodiments incorporate compliance with American Gas Association Protocols No. 3 (AGA3) and NO. 8 (AGA8) standards to interpret flow measurement and compressibility data, allowing for highly accurate control across variable pressure, temperature, and chemical regimes. Applications span oil and gas, manufacturing, product processing, and logistics coordination, where intelligent fluid interaction and predictive analytics are essential to operational efficiency and system resilience.

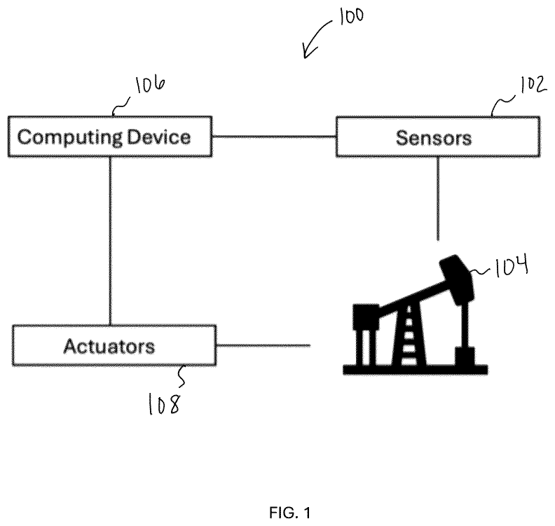

Referring to FIG. 1, illustrated is a schematic of one embodiment of an anthropomorphic AI control system 100 designed and constructed in accordance with the disclosed principles. Control system 100 may include a plurality of sensors 102 for gathering real-time data regarding one or more pieces of equipment in an industrial system 104. Industrial systems may include oil and gas drilling, oil and gas transport, oil and gas production, geothermal production, chemical manufacturing, food and beverage processing, pharmaceutical manufacturing, mining and mineral processing, wastewater treatment, fluid transport, and the like. One of ordinary skill in the art will recognize that control system 100 may be configured to measure, evaluated, and control equipment in industrial systems not specifically named herein. In the non-limiting exemplary embodiment illustrated in FIG. 1, the industrial system 104 may be an oil and gas drilling system. While the following disclosure describes control system 100 in the context of multiphase fluid flow management oil and gas drilling operations, it will be understood that control system 100 is highly adaptable to any industry system.

The plurality of sensors 102 may be configured to detect various stimuli including but not limited to light, sound, temperature, pressure, motion, chemical composition, and force to determine real-time equipment parameters. In an embodiment, sensors 102 may mirror human senses. The plurality of sensors 102 measure flow rate, pressure, temperature, density, viscosity, and chemical composition of fluid. The plurality of sensors 102 may be deployed across the equipment in the industrial system 104. As a non-liming example, sensors 102 may be distributed across mud pumps, flowlines, and shale shakers at a drilling facility. The plurality of sensors 102 may include, for example, a fiber optic system for recording acoustic signals of material flow at multiple facility locations. Fiber optic systems may non-invasively measure fluid flow by capturing acoustic signals generated by turbulence, vortex shedding, and other flow-induced vibrations. Fiber optic sensors may be distributed along a known tubular structure to record fluid flow data, which may be filtered and transformed to isolate key frequency ranges. For example, using the Doppler equation and the speech of sound, data collected by the fiber optic system can be used to determine the energy contributed by each phase in multiphase fluid flow. An exemplary fiber optic system for use with control system 100 is provided in U.S. Provisional Application No. 63/681,425 entitled “Optimal process flow heatmap”, which is incorporated herein in its entirety.

The plurality of sensors 102 may also include flow meters and pressure sensors to measure, for example, differential pressure across orifices, pit levels, and return line pressure. Pressure sensors may measure, for example, standpipe pressure, choke pressure, and casing pressure. In an embodiment, sensors 102 may include downhole pressure gauges and surface flow meters. Sensors 102 may also include viscometers and densimeters to measure, for example, current drilling fluid viscosity and weight (e.g., specific gravity) and rheology parameters for Reynolds number calculation and hydraulic modeling, described in greater detail below. For example, sensors 102 may include gamma-ray densitometers and optical particle counters. Sensors 102 may also include acoustic sensors to detect pack off, cavitation noise, and gas influx. Sensors 102 may also include cameras to collect visual data, including but not limited to drilling fluid color or cuttings. Sensors 102 may also include volume sensors to indicate volume gains/losses, chloride or H₂S sensors to detect chemical changes in fluid, and downhole measurement while drilling (MWD) and logging while drilling (LWD) telemetry to provide annulus pressure and temperature readings.

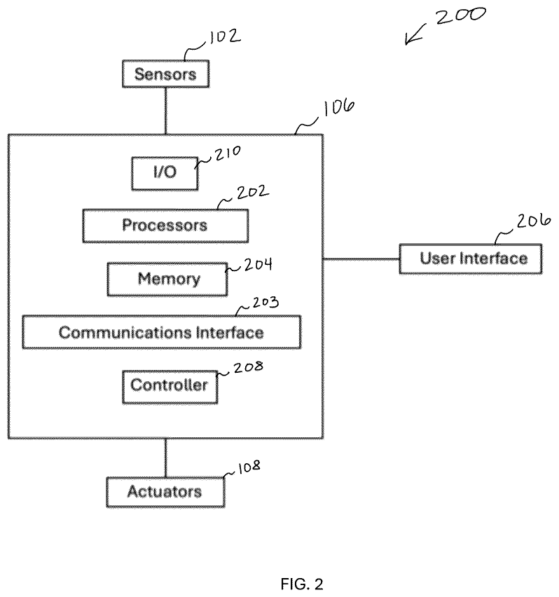

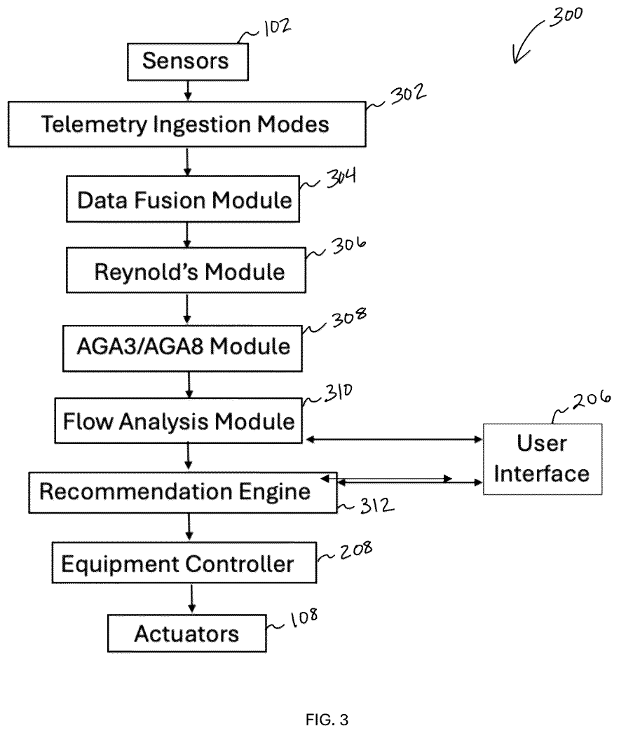

Data collected by the sensors 102 may be transmitted to a computing device 106 for processing and evaluation. Computing device 106 may include machine learning models (e.g., neural networks, reinforcement learning agents) trained to interpret fluid dynamics and control system parameters by modulating the operation of actuators 108, discussed in greater detail below. Computing device 106 may also be configured to predict and mitigate risk. Computing device 106 is discussed in greater detail with reference to FIGS. 2-3.

Control system 100 may also include actuators 108 to modify industrial system 104 operations. Actuators 108 may include various pieces of equipment at an industrial facility involved in controlling system operations. In the non-limiting exemplary embodiment illustrated in FIG. 1, actuators 108 may include, for example, automated control units (e.g., pumps, valve, additive injection systems) and separation equipment (e.g., centrifuges, shakers). The computing device 106 may adjust industrial system 104 operations based on real-time data and generated predictions by modulating actuators 108. As a non-limiting example, the computing device 106 may modulate pump speeds to maintain optimal flow regimes, modulate the injection of weighting agents (e.g., barite) or viscosifiers to adjust fluid properties, and control backpressure to prevent kicks (unexpected influxes of fluid/gas) or blowouts.

Referring to FIG. 2, illustrated is a block diagram 200 of an exemplary embodiment of a control system 100 in accordance with the disclosed principles. In this non-limiting exemplary embodiment, data from sensors 102 may be transmitted to a computing device 106. User input data collected by the user interface 206, discussed in further detail below, may also be transmitted to the computing device 106 for storage and analysis.

The computing device 106 may include one or more processing units 202 for processing and analyzing input data, generating recommendations and operation instructions, and generating output for delivery to the user. In one embodiment, the processing unit 202 may be artificial intelligence-enabled. Using machine learning models, the processing unit 202 can perform various functions to evaluate input data, identify trends, make recommendations, and modify operations utilizing anthropomorphic computing. That is, computing device 106 may mimic human-like decision-making by integrating reasoning, learning, and adaptation to dynamic conditions, thereby allowing the computing device 106 to process complex, multi-modal inputs (e.g., sensor data, historical trends, and operational heuristics) and emulate the nuanced decision-making of a human operator, such as contextualizing conflicting sensor data or anticipating operational anomalies. In an embodiment, processing units 202 may employ Python-based algorithms integrated with company-specific, customized software built from open-source frameworks such as TensorFlow or PyTorch to build and deploy the company's proprietary machine learning models. As a non-limiting example, the processing unit 202 may perform multi-sensor fusion to facilitate a detailed analysis of system operations and fluid flow. That is, the processing unit 202 may combine input data from the various sensors and databases described herein to generate a comprehensive and dynamic representation of the system being monitored and controlled. In an embodiment, the processing unit 202 may also use computer vision and 3D imaging to monitor a variety of system metrics. In the case of oil and gas drilling systems, metrics include but are not limited to drilling fluid cutting size and shape and drilling fluid color changes that could indicate barite sag or contamination.

Processing unit 202 may also analyze fused data to classify the state of the system, identify anomalies and optimization potential, generate a digital twin of the system, and generate predictive analytics and recommendations. For control of multiphase fluid flow the processing unit 202 may complete real-time Reynolds calculations using fused data and apply AGA3/AGA8 standards to accurately characterize fluid parameters. Based on these calculations and sensed and stored data, processing unit 202 may also complete comprehensive, real-time flow analysis. Processing unit 202 may generate predictions and recommendations based on flow analysis. The digital twin model may integrate physics governed equations and the mechanical properties of the actual installed systems based on sensor and meta data for the actual system monitored, including operating data indicating system condition and age of components.

The processing unit 202 can also generate output for delivery to the user via the user interface 206. Output may present multimodal data analysis in an intuitive way. As a non-limiting example, the output may include real-time data and trend visualization, workflow insights, predictive control guidance, adaptive recommendations, haptics, and alerts notifying the user of system anomalies. Output may also include, for example, equipment deviation heatmaps, interactive 3D reconstructions or a digital twin of equipment or fluid flow, natural language reports, and recommendations. As a non-limiting example, processing unit 202 may generate a report stating, “Kick suspected: flow-out>flow-in by 15%, pit volume up 2 bbl, acoustic gas signature detected.” The processing unit 202 may also analyze user input data and modify the machine learning model accordingly.

The processing unit 202 may be coupled to a memory 204 which can store input data for transmission, further processing, or later retrieval. The memory 204 may also contain an artificial intelligence-enabled program for analyzing and presenting data. Memory 204 may also include historical datasets representing, for example, past system and equipment performance, and equipment maintenance logs. Historical datasets may also represent, for example, fluid property trends, drilling logs, planned well parameters, formation characteristics, fluid performance, borehole stability, kicks, and lost circulation events. Memory 204 may also include operational heuristics including but not limited to expert-defined rules such as optimal mud weight windows or shale inhibition strategies, best practices, and AGA3/AGA8-compliant calculations for flow and compressibility. The memory 204 may also include fail-safe thresholds. The memory 204 may include one or more memory components, and may include non-volatile memory, volatile memory, or a combination of the two.

The computing device 106 may include an I/O unit 210 to allow for input and output of data. For example, the I/O unit 210 can provide a connection for user input through the user interface 206. The I/O unit 210 can also send output to the user interface 206.

The computing device 106 may also include a communications interface 203 to facilitate communication with other systems or devices. The communications interface 203 may support communications through any suitable physical or wireless communication link. For example, communications interface 203 may include a network interface card or a wired or wireless transceiver to facilitate communication over a network. The communications interface 203 may be used to facilitate cross-network deployment of the control system 100 across equipment, facilities, and operation centers. The communication interface 203 can be used to facilitate communication between multiple users. For example, the communications interface 203 may provide for operations (i.e., field operator, engineer, manager etc.) communication and communication between multiple industrial sites. If local Wi-Fi is used for device communication, it may be deployed in remote areas using a satellite communication such as Starlink. The communications interface 203 like Wi-Fi or Bluetooth may also facilitate communication between a user and the computing device 106. For example, the communications interface 203 may include a speech to text human machine interface, allowing users to provide input to the computing device 106 by speaking commands or providing equipment data. The communications interface 203 may also be enabled with an artificial intelligence-enabled large language model or more specialized small language model. In an embodiment, the language model may allow the user to access certification criteria, operational data in real-time or historical, original equipment manuals, engineering bulletins, prior inspection data, and other content relevant to the equipment and facility being monitored and controlled. While the computing device 106 may include a communications interface 203, it will be understood by one of ordinary skill in the art that the control system 100 may operate entirely offline. That is, the control system 100 may capture and analyze equipment data and control system operations, without communication with other systems or devices to support field work in low-connectivity areas and enable remote use. System data may be subsequently synchronized via the communications interface 203.

The computing device 106 may also include a variety of additional features not illustrated in FIG. 2. For example, the computing device 106 may include data security measures like end-to-end encryption. In an embodiment, all equipment and facility data (e.g., video, metadata, results, feedback) may be hashed, timestamped, and stored on secured end-to-end encrypted servers with hash matching. The computing device 106 may also include a data management system to optimize the storage, organization, and retrieval of data. As a non-limiting example, the data management system may allow data stored in the memory 204 to be deleted, updated, and/or retrieved according to an artificial intelligence-enabled program. The computing device 106 may also include flexible application programming interfaces (APIs) to allow communication with external software systems. As a non-limiting example, the flexible APIs may allow the computing device 106 to communicate with equipment management software to access equipment data.

The computing device 106 may also utilize edge computing to process data closer to the source (e.g., drilling rigs or fluid management units), reducing latency and bandwidth needs, improving data security, minimizing reliance on centralized cloud infrastructure, and enabling real-time data analysis and responsiveness to enhance resilience of the industrial system. Edge computing may also allow the computing device 106 to operate autonomously under intermittent connectivity in remote or harsh environments such as offshore drilling rigs. Edge computing may be supported by federated machine learning for multi-system learning and learning package redistribution among a plurality of control systems 100 without uploading private data from industrial equipment or systems to a central platform. As a non-limiting example, a computing device 106 may act as an independent node within a network of control systems 100, generating local updates based on unique equipment data. Local updates may be securely aggregated at a central server to refine the global machine learning model without transferring sensitive or personally identifiable information to the central server. The central server may aggregate the local updates from all participating control systems 100 through a secure federated aggregation process and then send the updated machine learning models back to individual control systems 100.

As previously discussed, the computing device 106 may also be coupled to one or more actuators 108 to modify system operations. The computing device 106 may include an equipment controller 208 to modulate actuator 108 activity in accordance with recommendations and/or triggers generated by the processing unit 202. Actuators 108 include but are not limited to pumps, valve, additive injection systems, centrifuges, shakers, and the like. Equipment controller 208 is discussed in greater detail with reference to FIG. 3.

The computing device 106 may also be coupled to one or more user interfaces 206 for delivery of the output generated by the processing unit 202 and collection of user input data, which may be analyzed by processing unit 202 and stored in memory 204. In an embodiment, user input data may be used to modify the output accordingly, thereby providing human-in-the-loop feedback. For example, using the user interface 206, operators may intervene, approve, or reconfigure suggested actions, adjust settings, and modify the digital twin. User input data may also include operations control decisions in response to recommendations. As a non-limiting example, a user may be able to edit incorrect components of the digital twin. For example, a user may be able to provide human-in-the-loop feedback by highlighting and modifying system parameters in real time during the inspection or remotely after the inspection. User input data may also include user confidence scoring wherein a user may rate the appropriateness of the recommendation. This data may be used as a training signal to prioritize high-disagreement cases in retraining the machine learning models.

Referring to FIG. 3, illustrated is a schematic of data flow of control system 100 used to control multiphase flow in accordance with the disclosed principles. In the non-limiting exemplary embodiment illustrated in FIG. 3, telemetry ingestion nodes 302 may receive real-time input from the plurality of sensors 102. Telemetry ingestion nodes 302 may time-align and clean the data. That is, the telemetry ingestion nodes 302 may filter noise and validate sensor 102 health. For example, telemetry ingestion nodes 302 may also apply an Extended Kalman Filter (EKF) for nonlinear process dynamics, an unscented Kalman Filter (UKF) when measurement noise is non-Gaussian, and/or particle filters for multimodal distributions (e.g., slug flow detection). Telemetry ingestion nodes 302 may also filter incoming data through a safety-constrained formulation logic. In an embodiment, telemetry ingestion nodes 302 may also calibrate sensor data.

The control system 100 may include a data fusion module 304 to aggerate multimodal data and provide a comprehensive view of fluid parameters, thereby enhancing anomaly detection and decision making. The data fusion module 304 aggregates data collected by the plurality of sensors 102, including but not limited to pressure, flow rate, density, acoustic, and visual data. For example, in drilling operations, the data fusion module 304 may fuse high-rate flowmeter data with lower-rate cuttings sensor data. The data fusion module 304 may also integrate data from sensors 102 with data retrieved from memory (not shown). As a non-limiting example, the data fusion module 304 may aggregate sensed flow rates and fluid pressures with historical datasets such as fluid property trends and lab test data stored in memory. The data fusion module 304 can integrate multiple data types for further processing by the computing device (not shown). The data fusion module 304 may integrate numerical time-series, images, and categorical data. As a non-limiting example, the data fusion module can simultaneously interpret structured data, such as continuous sensor readings (e.g., pressures, flow rates, RPM, etc.) which are numeric and time-stamped, unstructured data, such as mud log reports, rig operator notes, and sensor signals like sound or vibration that require spectral analysis, and visual data. Data fusion provides context for individual data points, allowing for identification of patterns and anomalies. Data fusion also ensures that if one sensor is faulty (e.g., a clogged DP line on the orifice), other modalities (like pit volume increase and acoustic signals of gas) can compensate, thereby increasing fault tolerance and reliability.

In an embodiment, the data fusion module 304 may also calculate flow vectors from data collected by a fiber optic system. Fiber optic sensors collect continuous Distributed Acoustic Sensing (DAS) data. DAS data may be converted into the time-frequency domain using techniques such as the Short-Time Fourier Transform (STFT) or Wavelet Transform. The F-K transform is applied to convert the time-frequency representation into the frequency-wavenumber domain using mathematical algorithms. The frequency-wavenumber domain provides valuable insights into the characteristics of the seismic signals, including underlying seismic structures and properties like frequency content and propagation direction. In an embodiment, the Doppler shift may be used to determine flow speed consistently across a fluid conduit. The Doppler shift is described be the equation f′=f*((v+v_obs)/(v+v_src)) where (f′) is the observed frequency, (f) is the emitted frequency, (v_obs) is the observer's velocity relative to the medium, (v_src) is the source's velocity relative to the medium, and (v) is the speed of the wave (e.g., speed of sound or speed of light). Using the F-K transformation and the Doppler shift, the speed of sound for waves traveling through the fluid conduit may be identified. More specifically, the difference between the speed of sound is the velocity of the flow and its direction. Speed of sound may also be used to determine fluid composition and enthalpy of the system.

The Reynolds module 306 calculates the Reynolds number (Re) or four-digit Reynolds code using fused data to detect density (rho), velocity (v), pipe or annulus diameter (D), and viscosity (mu) of the fluid according to the following formula: Re=(rho)(v)(D)/(mu). The calculated Re serves as a dynamic feature to classify flow regimes (e.g., laminar, transitional, or turbulent) and guide control actions to maintain fluid flow in an optimal regime, discussed in greater detail below. For example, control system 100 may use Re feedback to dynamically control pump speed and flow rate to maintain the desired flow regime. As a non-limiting example, control system 100 can detect Re trending toward transitional/laminar and automatically increase pump strokes or advise reducing viscosity (via dilution) to push Re back into turbulent range. Re may also be used to optimize hydraulic efficiency, thereby reducing wear on pumps and saving energy. For example, if Re is much higher than needed, control system 100 may safely reduce flow while remaining in turbulent regime, thereby reducing circulating pressure losses. Furthermore, Re offers a stable reference to tune system control. Instead of controlling pump output to a fixed value, controlling to a target Re allow control to adapt to fluid property changes. Control system 100 can directly use the difference between current Re and target Re as an error signal in a feedback controller to adjust pump speed. In oil and gas drilling, Re is an indicator of cuttings transport efficiency. Control system 100 may monitor Re to ensure it stays above a critical threshold for effective hole cleaning. Through adaptive machine learning, the control system 100 may adjust the minimum target Re depending on drilling fluid type (e.g., higher viscosity mud might need higher pump rates to achieve turbulence). The Reynolds module 306 may also invert the Reynolds formula to infer unmeasured fluid parameters such as fluid density or fluid viscosity. Inferred fluid parameters can be compared to target parameters to optimize fluid flow and mitigate risk.

The AGA3/AGA8 module 308 applies computational routines that reference MF3/AGA3 orifice flow measurement standards to calculate accurate flow rates of fluid and any entrained gases through orifice meters, and MF8/AGA8 gas properties standard to characterize gas properties within the fluid, ensuring precise characterization of multiphase fluids under varying pressure and temperature conditions. The computational routines may be tailored to multiphase flow and the unique rheology of the fluid being controlled. Computational routines may ingest full fluid properties and dynamically adjust core coefficients, thereby preserving protocol fidelity while handling gas-oil-water-solid interactions.

With regard to the MF3/AGA3 orifice flow measurement standards, the mass flow rate (\dot{m}) through an orifice is given by a formula derived from Bernoulli's principle, for example: \[\dot{m}=C_d\sqrt{\frac{1−\beta4}{}}; \epsilon; \frac{\pi d2}{4} \sqrt{2\rho_1Delta p}\] where (C_d) is the discharge coefficient, (\beta=d/D) the orifice bore-to-pipe diameter ratio, (lepsilon) the gas expansion (expansibility) factor, (\rho_1) the upstream fluid density, and (\Delta p) the measured pressure drop. In compressible flow, the expansibility factor (\epsilon) accounts for density change across the orifice The AGA3/AGA8 module 308 implements discharge-coefficient relationships analogous to MF3/AGA3, reengineered for the system's particular orifice geometries. The AGA3/AGA8 module uses fused data to continuously calibrate the effective orifice coefficient (C) and utilizes a lightweight machine-learning overlay to correct for non-Newtonian viscosity and slip effects among components such as gas bubbles, oil phases, and solid particles.

The MF8/AGA8 gas properties standard is a detailed characterization method to find gas density and compressibility (Z) for natural gas mixtures. Given a gas composition or observed pressure/temperature, MF8/AGA8 yields the supercompressibility factor (Fpv) used in flow equations. Specifically, MF8/AGA8 provides Z at line conditions, allowing correction of volumes to standard conditions and calculation of gas density. The AGA3/AGA8 module 308 encodes the virial-series approach of MF8/AGA8 for Z, optimized for on-edge inferencing, and extends standard MF8/AGA8 models with correction terms for oil and water volume fractions, plus solids-loading adjustments from real-time viscometer and solid size data.

The AGA3/AGA8 module 308 updates compressibility profiles every few seconds. In drilling operations, this enables precise equivalent circulating-density (ECD) control under evolving downhole pressure and temperature. Liquid flow rate and gas flow rate (or gas volume fraction) may be logged as separate channels to ensure that flow measurement remains precise across single-phase (liquid) and two-phase (gas-liquid) conditions, which is essential for anomaly detection. As a non-limiting example, the AGA3/AGA8 module 308 may retrieve (\Delta p), upstream pressure (P_1), temperature (T), and fluid data and use MF3/AGA3 equations to compute fluid flow rate (Q_m). When gas is detected by a gas sensor, AGA3/AGA8 module 308 may be triggered to use the MF8/AGA8 equations to calculate gas compressibility (Z) from sensed gas composition or P-T data. The flow calculation may be adjusted with the expansibility factor (\epsilon) and supercompressibility factor (F_{pv}) to accurately compute total volumetric flow including gas.

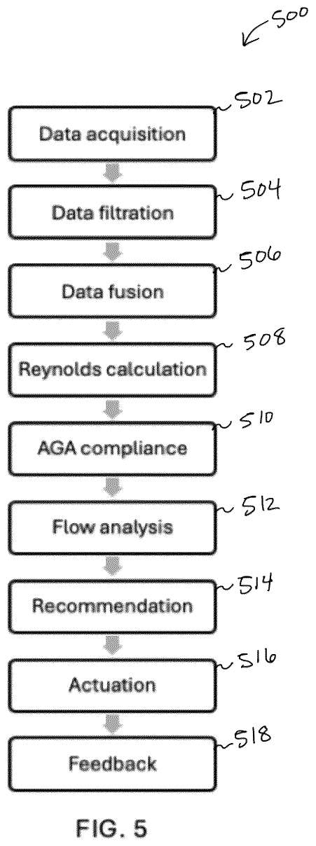

Additional modules configured to calculate fluid metrics may also be included. For example, control system 100 may include modules to calculate gas fraction, fluid loss, and trend gradients, and identify out-of-bounds values. An exemplary drilling fluid loss module is described in greater detail below. Control system 100 may also include a supply chain management module, described in greater detail with reference to FIG. 5.

Data processed by the data fusion module 304, Reynolds module 306, and AGA3/AGA8 module 308 may be sent to the flow analysis module 310 to analyze fluid parameters. As a non-limiting example, the flow analysis module 310 may employ a machine learning model, rule-based expert systems, neural networks, and/or ensemble models to analyze fluid data. The flow analysis module 310 may analyze fused data and calculated parameters to classify the state of the system, infer unmeasured parameters, and predict near-future trends. The flow analysis module 310 may classify fluid flow into (Re<2000), transitional (2000<Re<4000), or turbulent (Re>4000) states. The flow analysis module 310 may also compare the calculated and inferred fluid parameters to target fluid parameters. Re targets may be dynamically recalibrated based on real-time rheology inputs. In the case of oil and gas drilling operations, the target Re might change depending on drilling phase. For example, during critical drilling phases (like drilling out a gas-bearing zone), target Re may be very high to maximize vigilance for faster kick detection.

The flow analysis module 310 may also generate predictive analytics to predict fluid behavior, equipment performance, and operational risks. For example, the flow analysis module 310 may identify early signs of equipment wear, fluid instability, or formation issues and generate predictive analytics regarding system operation. In an embodiment, the flow analysis module 310 may implement a model predictive controller to anticipate lithology changes. The flow analysis module 310 may also cross-reference real-time sensor data with historical trend and heuristics data stored in the memory to predict near-future trends and mitigate risk. For example, the flow analysis module 310 may predict the likelihood of a kick in progress, estimate required fluid weight changes, or identify an outlier suggesting sensor malfunction. As another example, the flow analysis module 310 may correlate a sudden pressure spike with historical instances of equipment wear, thereby predicting failures before they occur. As another example, the flow analysis module 310 may predict a time-specific pit volume based on current trends.

The flow analysis module 310 may also generate a high-fidelity digital twin of the system being monitored and controlled. Live sensor data may be synchronized with the digital twin for continuous adaptive control and predictive maintenance. In an embodiment, the fluid analysis module 310 may map fluid parameters to the digital twin, leveraging pre-trained models and lookup tables. The digital twin ensures real-time reconstruction with low latency, enabling dynamic process optimization. The digital twin may also be used for “what-if” scenario testing. In an embodiment, the digital twin may be cloud-based. In an embodiment, the digital twin may be based solely on the four-digit Re identifier, which may be sent to the cloud. The cloud-based system may reconstruct the full process twin using the Re, enabling real-time monitoring, simulation, and optimization without requiring raw process data. A reconstruction algorithm may decode the Re to extract embedded fluid dynamics parameters and generate a digital twin. By basing the digital twin solely on the four-digit Re identifier, data transmission, costs, latency, and the risk of data interception are greatly reduced.

Based on predictive analytics generated by the flow analysis module 310, the recommendation engine 312 may recommend and/or trigger mitigating operations to reduce risk, improve equipment longevity, and optimize operations. For example, the flow analysis module 310 may identify a trend toward turbulent flow. In turn, the recommendation engine 312 may trigger preventive measures such as valve adjustment before operational disruptions due to flow instability occur. As another example, the flow analysis module 310 may identify anomalous pressure readings indicating gas influx. The recommendation engine 312 may trigger predictive mitigation like increasing fluid weight. As previously discussed, the flow analysis module 310 may also cross-reference real-time sensor data with historical trend and heuristics data to predict near-future trends. The recommendation engine 312 may use this data to recommend risk mitigating strategies. For example, a high Re combined with historical data on pipe wear might trigger a maintenance alert, while a low Re could prompt optimization of fluid viscosity for laminar flow.

As previously described, the equipment controller 208 may modulate actuators 108 activity to modify system operations based on recommendations and/or triggers generated by the recommendation engine 312. For example, the equipment controller 208 may modify additive injection equipment operation to adjust fluid properties such as viscosity and density to maintain stable fluid flow. The equipment controller 208 may also optimize pump rates and flow regimes to minimize energy consumption while maintaining operational stability. In operation with an oil and gas drilling system, the equipment controller 208 may modulate the operation of a shale shaker by selecting an optimal screen mesh based on measured solids size distribution, adjusting vibration amplitude/frequency to maximize cuttings removal while minimizing fluid carry-over, and regulating flow divider valves to balance inlet volumes across shaker decks. The equipment controller 208 may modulate a hydrocyclone (e.g., a desander/desilter) by tuning feed pressure and vortex finder dimensions to target specific cut-point for sand and silt removal and modulating underflow discharge rate to maintain optimal separator efficiency. The equipment controller 208 may modulate a centrifuge for solids separation by, for example, setting bowl G-force and scroll differential speed according to solids concentration and particle density, scheduling no-flow intervals for solids discharge and bowl cleaning, and monitoring torque to prevent overloading and trigger preventive maintenance alerts. The equipment controller 208 may modulate a degasser by, for example, regulating vacuum level and recirculation rate to strip entrained gases and integrating MF8/AGA8 routines upon gas-detection sensor triggers to quantify and react to influx events. The equipment controller 208 may modulate a filtration skid by, for example, engaging backwash or element changeover based on differential pressure thresholds and activating bypass valves when solids loading exceeds setpoints. The equipment controller 208 may modulate an additive dosing unit to execute closed-loop pH adjustments, corrosion inhibitor injection, defoamer addition, and rheology modifier dosing and choosing chemical blends (e.g., PHPA, lignosulfonates) based on formation type and real-time fluid loss readings. The equipment controller 208 may modulate a temperature by switching chiller or heater circuits to maintain target drilling fluid temperature for viscosity stability. Each adjustment may be recorded in memory for later analysis and machine learning.

As a non-limiting example, if an impending kick is detected by the flow analysis module 310, the recommendation engine 312 may trigger the equipment controller 208 to activate an alarm, close the blowout preventer (BOP) or choke, increase injection of weighting agents to increase fluid viscosity, and increase pump output to control pressure. In operation with a drilling system, the equipment controller 208 may also engage a Managed Pressure Drilling choke control mode to compensate for the influx by maintaining constant bottomhole pressure. As another non-limiting example, if normal fluid flow is detected, the equipment controller 208 may adjust pump speed, choke, or feeder valves to maintain optimal fluid properties. For example, if Re is below target (e.g., flow becoming laminar), the equipment controller 208 may increase flow rate by adjusting pump speed or reduce fluid viscosity by injecting a thinning additive. If Re is too high (e.g., excess turbulent causing high friction pressure), the equipment controller 208 may slightly reduce pump rate to avoid fracturing. As another non-limiting example, if the flow analysis module 310 detects an anomaly or issue with a sensor 102, the equipment controller 208 may request a calibration sequence to adjust and verify the accuracy of the sensor 102. For instance, if orifice reading seems faulty, the equipment controller 208 may prompt an inspection or switch to backup flow measurement method. As another non-limiting example, in the context of drilling systems, if loss of circulation is detected by the flow analysis module 310, the recommendation engine 312 may cause the equipment controller 208 to activate an alarm, reduce the pump rate, and inject lost-circulation material.

Output from each module 302, 304, 306, 308, 310, 312 may be collected, storage, and used to train the machine learning model using adaptive learning to allow dynamic adaptation to changing system conditions, such as temperature fluctuations or unexpected formation fluid influx, ensuring operational resilience. In an embodiment, control system 100 may include a 1-second feedback loop for real-time response. In an embodiment, reinforcement learning agents may optimize long-term performance by learning control policies that balance efficiency, safety, and fluid stability. Feedback outputs may also be used to update the digital twin of the system. Feedback outputs may also be used to update fluid program parameters over time. For example, as drilling progresses into a different formation, the baseline gas level or noise patterns might change. Using feedback loops, the control system 100 can quickly recalibrate thresholds on the fly. Control system 100 may refine its machine learning model with each incident to reduce false alarms or improve sensitivity.

A non-limiting example illustrating operation of control system 100 is provided. In an embodiment, sensors 102 may detect a flow rate of 0.5 m/s, density of 1200 kg/m³, viscosity of 0.02 Pa·s, and pipe diameter of 0.1 m. The telemetry ingestion nodes 302 may receive and filter sensed data. The data fusion module 304 may aggregate this data along with stored data to provide a comprehensive view of fluid parameters. The Reynolds module 306 may calculate a Reynolds number of 3000 based on the data collected by the sensors 102 according to the Reynolds formula. The AGA3/AGA8 module 308 may complete MF3/AGA3 calculations to validate flow measurements and MF8/AGA8 calculations to adjust for compressibility if gas is present in the drilling fluid. The flow analysis module 310 may analyze the Reynolds number calculated by the Reynolds module 306, Re=3000, alongside pressure and temperature trends stored in the memory to classify the sensed flow as transitional and predict potential turbulence. The flow analysis module 310 may update the digital twin accordingly. The recommendation engine 312 may recommend reducing pump speed by 5% and injecting a viscosifier to lower Re to ˜2000 for laminar flow. The equipment controller 208 may control actuators to stabilize the flow. As a non-limiting example, the equipment controller 208 may adjust pump speed and inject additives to stabilize the flow. The digital twin may be updated according to continuous data feeds, updates on the Reynolds numbers and other parameters, thereby refining predictions from the flow analysis module 310 and equipment controller 208 outputs.

As another non-limiting example, sensors 102 may detect fluid velocity (0.6 m/s), density (1150 kg/m³), viscosity (0.018 Pa·s), diameter (0.25 m), pressure (150,000 Pa), and temperature (300 K). The telemetry ingestion nodes 302 may receive and filter sensed data. The data fusion module 304 may aggregate this data along with stored data to provide a comprehensive view of fluid parameters. The Reynolds module 306 may calculate a Reynolds number of approximately 9583 based on the data collected by the sensors 102 according to the Reynolds formula. The AGA3/AGA8 module 308 may validate flow measurements using MF3/AGA3 calculations and adjust for potential gas content using MF8/AGA8 calculations. Based on data from the data fusion module 304, Reynolds module 306, and AGA3/AGA8 module 308, the flow analysis module 310 may predict formation erosion risk due to turbulence. The flow analysis module 310 may update the digital twin accordingly. The recommendation engine 312 may recommend increasing viscosity to 0.025 Pa·s (via polymer dosing) and reducing velocity to 0.4 m/s, targeting Re of approximately 1800 for laminar flow. The equipment controller 208 may slow pump speeds and cause an additive injector to doses xanthan gum, thereby stabilizing the flow. Again, the digital twin may be updated according to continuous data feeds, updates on the Reynolds numbers and other parameters, thereby refining predictions from the flow analysis module 310 and equipment controller 208 outputs.

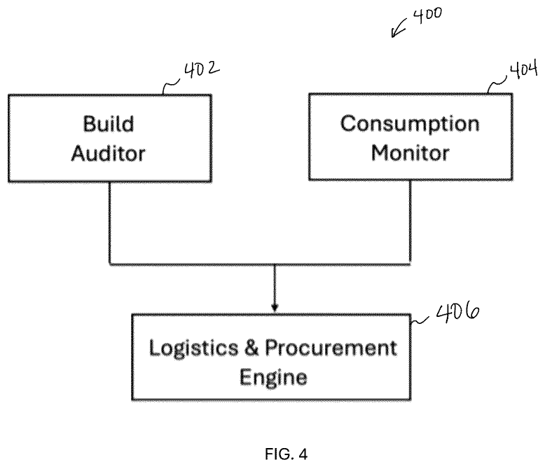

Referring to FIG. 4, illustrated is a schematic 400 of an integrated supply chain management module. The supply chain management module may integrate operational data with a system's Enterprise Resource Planning (ERP) system to facilitate integrated supply chain management. The supply chain management module may include a build auditor 402 to determine the necessary supplies for system construction based on system plans and programs, as well as sensed facility data. In operation with a drilling system, the build auditor 402 may ingest the digital well plan, drilling-fluid program, and sensor data to auto-generate, track, and replenish every fluid and additive required—down to LCM blends and viscosity pills—throughout well construction. Digital well plans may include, for example, section depths, casing/tubing sizes, planned mud weights, circulation rates. Drilling fluids programs may include, for example, target rheology profiles, density requirements, additive schedules (e.g., viscosifiers, weighting agents, LCM recipes). Sensor input from tank-level gauges, load-cell scales under additive bins, and RFID tagging on drums is continuously provided to the supply chain management module. Using this input, the build auditor 402 may calculate slurry volume and additive quantities. For example, the build auditor 402 may compute pit volume and circulation-loop volumes for the top hole, intermediate, production zones. Build auditor 402 may also derive mass and volume for each chemical (e.g., polymers, barite, LCM components) based on target concentrations and section lengths. Using these calculations, the build auditor 402 may generate a bill of materials (BOM) output including a structured list of products, grades, and quantities wherein each item is tagged with a section assignment and a delivery window.

The supply chain management module may also include a consumption monitor 404 to monitor supply consumption, analyze schedules, and predict needs. For example, the consumption monitor 404 may compare expected fluid and additive usage from the BOM to actual drawdown data gathered by sensors. The consumption monitor 404 may also infer shake screen life from vibration metrics and throughput mass, and monitor centrifuge scroll torque and cycles counts for bowl screw replacement. The consumption monitor 404 may flag variances and evaluate the likely underlying cause. For example, over-consumption of viscosifier may indicate shale instability. Using this data, consumption monitor 404 may update remaining inventory in real time, recalculate needs for upcoming sections, and adjust BOM if well conditions shift. Consumption monitor 404 may continuously reconcile predicted versus actual usage to recalibrate forecasts and procurement thresholds. Consumption and loss-control performance data may be stored to monitor performance and improve volume-estimation models. For example, the consumption monitor 404 may refine future BOMs to minimize over-ordering and reduce idle inventory. The consumption monitor 404 may also predict potential supply shortfalls under adverse drilling scenarios (e.g., elevated LCM demand) and trigger contingency shipments or cross-site reallocations.

The supply chain management module may also include a logistics and procurement engine 406 to generate a Material Requirements Planning (MRP) schedule, automate purchase orders when inventory thresholds are breached, and optimize delivery and staging. The logistics and procurement engine 406 may calculate reorder points using lead times, site consumption rates, and safety stocks, and prioritize critical path additives. The logistics and procurement engine 406 may also format and issue purchase orders to approved vendors with part numbers, volumes, and requested delivery dates, and integrate with ERP systems for confirmation and invoice matching. The logistics and procurement engine 406 may also employ AI-driven route planning for multi-stop deliveries to on-site depots or satellite yards and generate automated staging instructions such as rack positioning, batch numbering, and expiration tracking. The logistics and procurement engine 406 may also generate on-screen prompts to guide operators through consumable swap-out, with QR-code scans to confirm lot and date. As a non-limiting example, in operation with an oil and gas drilling system, the logistics and procurement engine 406 may queue orders for screens when the screen wear index or pressure drop exceeds predefined limits, centrifuge consumables (e.g., scrolls, seals) when torque-hours approach end-of-life, and additives when concentration levels fall below a minimum volume. The logistics and procurement engine 406 may also generate instructions for automated guided vehicles or overhead cranes to stage replacement parts at the conditioning skid.

Referring to FIG. 5, illustrated is a method 500 for monitoring and controlling an industrial facility in accordance with the disclosed principles. The steps of method 500 may be implemented by an industrial control system, such as control system 100 exemplified and disclosed herein. In one or more embodiments, one or more of the steps may be omitted, repeated, and/or performed in a different order. Accordingly, the specific arrangement of steps shown in FIG. 5 should not be construed as limiting the scope of the embodiments.

Method 500 begins at Step 502, wherein real-time multimodal data corresponding to system operation is collected using a plurality of sensors. Multimodal data may include, for example, fluid pressure, flow rate, fluid density, fluid pathway geometrics, composition, and volume. Multimodal data may be collected using a plurality of sensors. In Step 504, data may be filtered. For example, multimodal data may be filtered for noise. Multimodal data may also be filtered through a safety-constrained formulation logic. In Step 506, multimodal data may be fused. That is, various data types from multiple sources may be aggregated to provide a comprehensive view of system parameters. For example, pressure, flow rate, density, acoustic, and visual data may be fused. Sensor data may also be fused with data retrieved from a memory, such as historical and heuristics data. In Step 508, the Reynolds number may be calculated. The Reynolds number may be calculated from sensed and stored fluid parameters. In an embodiment, the Reynolds formula may be inverted to infer unmeasured fluid parameters. In Step 510, AGA compliance may be applied to accurately characterize flow rates and gas properties within a fluid. AGA compliance may be applied using computational routines that reference MF3/AGA3 orifice flow measurement standards meters and MF8/AGA8 gas properties standards. The computational routines may be tailored to multiphase flow and the unique rheology of the fluid being controlled.

In Step 512, flow may be analyzed and a digital twin may be generated using an AI-enabled program. For example, measured and inferred fluid parameters may be compared to target parameters. The calculated Reynolds number may be used to classify flow regimes and guide control actions to maintain fluid flow in an optimal regime. Flow analysis may also include generating predictive analytics to predict fluid behavior, equipment performance, and operational risks. In Step 514, a recommendation corresponding to the flow analysis may be generated using an AI-enabled program. For example, if flow analysis identifies a trend toward turbulent flow, a recommendation for preventive measures such as valve adjustment before operational disruptions due to flow instability occur may be generated.

In Step 516, actuator operation may be modulated to modify system operation in accordance with the recommendation. For example, additive injection equipment operation may be modulated to adjust fluid properties such as viscosity and density to maintain stable fluid flow. Other examples include but are not limited to modulating pump speeds to maintain optimal flow regimes and controlling backpressure to prevent kicks (unexpected influxes of fluid/gas) or blowouts. In Step 516, sensor data and actuator commands may be recorded and used to train AI algorithms.

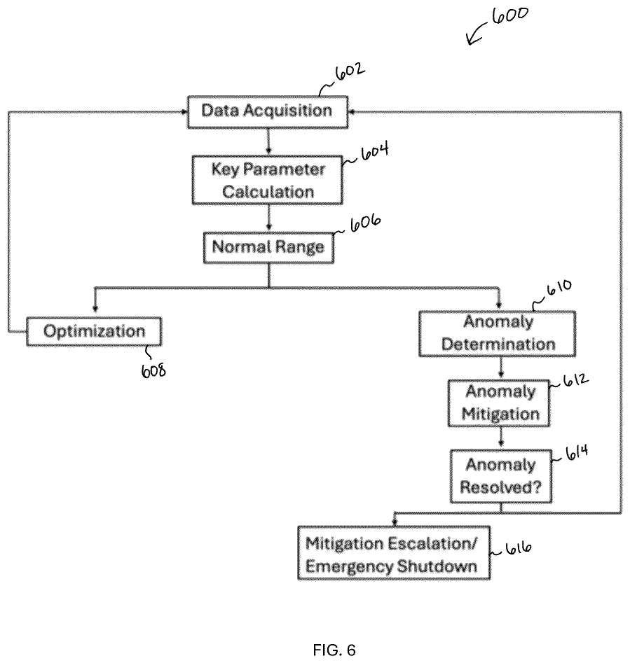

Referring to FIG. 6, illustrated is an exemplary system control sequence 600 for use with a control system in an oil and gas drilling operation in accordance with the disclosed principles. The steps of control sequence 600 may be implemented by an industrial control system, such as control system 100 exemplified and disclosed herein. In one or more embodiments, one or more of the steps may be omitted, repeated, and/or performed in a different order. Accordingly, the specific arrangement of steps shown in FIG. 6 should not be construed as limiting the scope of the embodiments.

Control sequence 600 begins at Step 602, wherein multimodal data corresponding to system operation is collected. Multimodal data may include, for example, fluid pressure, composition, and volume.

In Step 604, key parameters are calculated from multimodal data. As previously discussed, key parameters may be calculated. Key parameters include but are not limited to flow rate, gas fraction, Reynolds number, and delta flow. As previously discussed, flow and gas rates may be standardized to account for non-Newtonian flow.

In Step 606, parameters are compared to predefined standards. If parameters are determined to be within predefined standards, control sequence 600 proceeds to Steps 608 for optimization. If parameters are determined to be outside predefined standard, control sequence 600 proceeds to Step 610 for anomaly detection and correction.

In Step 608, the target Reynolds number is calculated for effective cuttings transport compared to the actual Reynolds number. If the actual Reynolds number is not equal to the target Reynolds number, the Reynolds number is corrected. For example, if the actual Reynolds number is below the target Reynolds number, Re is raised by increasing pump output and/or reducing fluid viscosity. If the calculated Reynolds number is above the target Reynolds number, Re is lowered by decreasing pump output and/or increasing fluid viscosity. The measured fluid density and viscosity are compared to programmed setpoints in Step 608. If the measured fluid density and viscosity are outside the predefined setpoints, additives are added to the fluid to correct density and viscosity. Control sequence 600 may return to Step 602 to repeat control sequence 600 for continuous monitoring and control of the system during operation.

As previously mentioned, if key parameters are determined to be outside predefined standards in Step 606, control sequence 600 proceeds to Step 610, wherein the type of anomaly is determined. Anomalies include but are not limited to gas kicks, fluid loss, and viscosity/rheology issues.

In Step 612, the anomaly is mitigated. For example, an alert corresponding to the type of anomaly detected may be generated. Additionally, a mitigation recommendation is generated and/or a mitigation routine is triggered. For example, if a gas kick is detected, the control system may trigger an alert and a kick mitigation routine including closing the BOP, notifying crews, etc. As another example, if fluid loss is detected, the control system may recommend or trigger lowering the pump rate and adding LCM.

In Step 614, it is determined whether the anomaly is resolved. If the anomaly is resolved, control sequence returns to Steps 602-608 for optimization. If the anomaly is not resolved, control sequence 600 proceeds to Step 616 wherein the mitigation routine is escalated or an emergency shutdown is triggered.

### Water-Based Drilling Fluid Use Case Example

The control system 100 is highly applicable to managing water-based drilling fluids during the construction of top hole and intermediate sections of a wellbore, which present unique challenges due to their shallow depths, unconsolidated formations, and complex fluid dynamics. Furthermore, drilling fluids have distinct rheological and chemical profiles with variable density, viscosity, and solid content. Leveraging real-time data, predictive analytics, and adaptive control, control system 100 may address these challenges by dynamically managing flow conditions and drilling fluid properties such as viscosity, density, and gel strength to maintain wellbore stability and prevent issues like stuck pipe or lost circulation.

More specifically, control system 100 can manage water-based drilling fluids during top hole and intermediate well construction by leveraging real-time Reynolds number calculations, multi-modal data assimilation, MF3/AGA3 and MF8/AGA8 compliance, and edge computing to address the unique challenges of these phases (i.e., lost circulation, wellbore instability, shale swelling, and cuttings transport) through predictive analytics and adaptive control. By dynamically adjusting drilling fluid properties and flow conditions, the control system 100 can enhance drilling equipment longevity, operational efficiency, safety, and environmental compliance. For example, control system 100 may reduce bottoms-up time, BHA flow-by issues, and LCM waste. Control system 100 may also minimize waste and energy use, thereby enhancing sustainability.

As previously discussed, control system 100 may include a plurality of sensors. In oil and gas drilling operations, sensors include but are not limited to surface and downhole flowmeters, real-time MWD/LWD measurements to determine annulus geometry, on-mud-pit densitometers or gamma-based sensors, API/Fann viscometer—used for calibration, and cuttings sensors (e.g., optical particle counters, ultrasonic). Using data collected by the sensors, control system 100 may conduct real-time Reynolds number calculation, parameter inference, and flow regime management to optimize drilling fluid properties (e.g., density, viscosity, salinity) during top hole and intermediate section drilling to ensure wellbore stability and efficient cuttings transport. Top hole drilling often uses large-diameter pipes and high flow rates (e.g., 1-2 m/s), leading to transitional or turbulent flow. The control system 100 monitors Re to detect turbulence, which can erode unconsolidated formations or cause excessive pressure losses. If Re exceeds 4000, the control system 100 may reduce pump speed or inject viscosifiers (e.g., xanthan gum) to increase fluid viscosity, thereby lowering Re to maintain laminar flow (˜1400-2000) for better cuttings transport and reduced formation damage. In the intermediate sections, narrower well geometries and changing fluid properties (e.g., due to temperature or cuttings loading) can shift flow regimes. The control system 100 may adjust pump rates or additive dosing to stabilize Re within optimal ranges, ensuring efficient cuttings transport without destabilizing shales. For example, for a water-based drilling fluid with measured fluid density of 1100 kg/m\hat{ }3, fluid velocity of 0.8 m/s, pipe or annulus diameter of 0.2 m, and viscosity of 0.015 Pa·s, the control system 100 calculates Re=(1100)0(0.8)(0.2)/(0.015) to determine a Re of approximately 11,733, indicating turbulent flow. In response, control system 100 may reduce fluid velocity to 0.5 m/s or increase fluid viscosity to 0.02 Pa·s, targeting Re of approximately 2000.

Control system 100 may also aggregate multimodal drilling fluid data from real-time sensors such as flowmeters, densitometers, viscometers, pressure transducers, and temperature sensors, historical data, and operational heuristics to provide a comprehensive view of fluid parameters. For example, in top hole drilling, control system 100 may correlate Re, pressure, density, and formation data with historical pressure and lost circulation events to prevent fluid loss. For example, if a high Re coincides with a pressure spike in a porous formation, control system 100 may predict fluid loss and adjusts fluid weight (e.g., by adding barite) or seal fractures with lost circulation materials (LCMs). Loss detection and control is described in more detail below. Control system 100 may also ensure laminar flow for efficient cuttings transport by maintaining Re<2000 and adjusting viscosity or flow rate based on real-time cuttings load data from shale shakers. In intermediate section drilling, control system 100 may monitor drilling fluid salinity and pH (via chemical sensors) alongside Re to prevent shale hydration and ensure shale stability. If swelling is detected (e.g., via torque increase), control system 100 may inject inhibitors like potassium chloride to improve shale stability. Control system 100 may also maintain drilling fluid weight within the pore pressure-fracture gradient window, thereby preventing kicks or formation damage.

Control system 100 may also ensure MF3/AGA3 and MF8/AGA8 compliance to ensure accurate flow and compressibility data, which is vital for managing multiphase water-based drilling fluids. MF3/AGA3 compliance ensures accurate flow measurement in the drilling fluid circulation system, which is critical for top hole sections where high flow rates are common. As previously discussed, control system 100 may correct for non-Newtonian viscosity and slip effects among components such as gas bubbles, oil phases, and solid particles. Control system 100 may use MF3/AGA3-corrected flow data to refine Re calculations and validate sensor accuracy. The MF3/AGA3 integration leverages existing gas industry calibration data to improve flow accuracy. More specifically, control system 100 may use data collected by a differential-pressure flowmeter on the drilling mud return line to monitor flow-out from the wellbore. The control system 100 then takes the measured (\Delta p), fluid density, and orifice characteristics to compute flow rate via the MF3/AGA3 algorithm to provide a standardized, traceable flow measurement of drilling returns. This standardized flow measurement may be used to detect kicks or fluid losses by comparing flow-out to pump flow-in.

MF8/AGA8 compliance accounts for gas content in drilling fluid, which is particularly important in intermediate sections where gas influx from formations is a risk, and enables detection and management of gas kicks. Control system 100 can estimate the volume of gas in the fluid returns by comparing measured gas-corrected flow to liquid flow. Additionally, if gas composition sensors or fluid logs provide gas makeup (e.g., methane, hydrocarbons), MF8/AGA8 compliance helps compute precise density and energy content of the gas. The control system 100 may adjust compressibility factors to ensure precise density and pressure calculations, enabling accurate drilling fluid weight control. Furthermore, if gas sensors detect gas flowing through the orifice meter, the control system 100 may incorporate the Z calculated using MF8/AGA8 to adjust the flow rate calculation.

Control system 100 may also provide predictive analytics to anticipate issues like lost circulation, shale instability, or gas kicks, and mitigate risk and downtime. In top hole drilling, control system 100 may provide predictive analytics regarding fluid loss by analyzing Re, pressure trends, and formation data. For example, a sudden drop in return flow with stable Re might indicate losses, thereby prompting control system 100 to inject LCMs. Control system 100 may also provide predictive analytics regarding wellbore stability. For example, by correlating Re with torque and drag data, the control system 100 may anticipate formation collapse in unconsolidated zones and adjust mud density or flow rate accordingly to stabilize the wellbore. In drilling the intermediate section, the control system 100 may detect early signs of gas influx (e.g., pressure anomalies or compressibility changes via MF8/AGA8) and predict kick risks, triggering choke valve adjustments or fluid weight increases. Control system 100 may also identify shale swelling risks by analyzing fluid chemistry and formation data, prompting preemptive inhibitor dosing.

As previously discussed, control system 100 may employ edge computing. Top hole and intermediate sections are often drilled in remote locations (e.g., offshore rigs) with limited connectivity. The edge-deployed control system 100 may process data locally, ensuring real-time control without reliance on cloud infrastructure. As a non-limiting example, edge devices (e.g., industrial PLCs) may calculate Re, apply MF3/AGA3 and MF8/AGA8 corrections, and run artificial intelligence models to issue control commands, such as pump speed adjustments or additive dosing.

Control system 100 may also provide adaptive control of drilling equipment and fluid flow. As previously described, control system 100 may control shale shakes, hydrocylones (desander/desilter), centrifuges, degassers, filtration skids, additive dosing units, and temperature controls to modify system operations. In top hole drilling, control system 100 may adjust drilling fluid viscosity (via polymer dosing) and density (via barite addition) to maintain laminar flow and prevent lost circulation. For example, if Re approaches 4000, control system 100 may increase fluid viscosity to stabilize flow. Control system 100 may also optimize pump speeds by balancing high flow rates against energy efficiency. For example, the control system 100 may reduce pump speed when laminar flow is achieved, thereby minimizing wear on equipment. In intermediate section drilling, control system 100 may use real-time drilling fluid pH and salinity data to dynamically dose inhibitors to prevent shale hydration. Control system 100 may also adjust choke valves to control annular pressure and maintain stability against formation pressures. Control system 100 may also optimize flow rates to ensure cuttings are transported without settling. For example, control system 100 may adjust Re to ˜1400-2000 for laminar flow. As previously discussed, edge deployment and real-time Re calculation enables rapid responses to dynamic conditions, such as sudden formation changes or gas influx.

As previously described, control system 100 may identify and control drilling fluid loss. Control system 100 may employ real-time analysis of system characteristics to detect early signs of fluid loss. As previously described, control system 100 may fuse multimodal data to provide a comprehensive view of fluid parameters. For example, control system 100 may fuse data regarding pump-in/pump-put differentials, pit volume trends, standpipe pressure fluctuations, annular flow rate, and acoustic and vibration anomalies to detect fluid loss. Control system 100 may also classify fluid loss severity. As a non-limiting example, fluid loss severity may be classified as follows: Seepage: <5 bbl/hr; Partial Loss: 5-50 bbl/hr; Severe Loss: 50-300 bbl/hr; Total Loss: >300 bbl/hr. Control system 100 may continuously compares real-time data against historical baselines and apply pattern recognition to differentiate leak types (e.g., fracture vs. permeable zone leak). Control system 100 may continuously monitor pressure differentials between the drill string and annulus such that loss alerts within seconds when loss rate and pressure-drop criteria are met. AI-driven anomaly detection filters can sensor noise to avoid false positives, ensuring timely intervention.

Control system 100 may mitigate fluid loss by modulating actuators such as LCM mixers and hoppers, dosing pump controllers, and injection manifolds and valves to mitigate fluid loss. LCM mixers and hoppers may blend dry LCM stocks into carrier fluid in accordance with a ratio determined by the control system 100, described in greater detail below. The dosing pump controller modulates injection pressure and flow based on loss severity. The injection manifold directs slurry to the drill pipe or annulus, with check valves to prevent backflow.

Control system 100 may implement tiered fluid loss control based on fluid loss severity and timing. As a non-limiting example, control system 100 may implement preemptive mitigation by adjusting drilling fluid weight and rheology to maintain ECD within safe window and injecting micro-sized bridging agents at first sign of seepage. Control system 100 can calculate injection rates and blend ratios. Particle-size distribution algorithms may be used to determine optimal LCM blend (fiber, granular, flake) based on estimated fracture aperture and loss rate. As non-limiting examples, control system 100 may inject fiber LCM (e.g., cedar fiber) slurry with 50-400 μm particles and a low-rate dosing (e.g., 5-10 ppb) when fluid loss severity is classified as Seepage as described above. A severity classification of Partial may result in injection of granular LCM (e.g., nutshells, calcium carbonate) with 50-400 μm particles at medium pressure at 10-25 ppb, and a severity classification of Severe may result in injection of a Flake/Blend LCM (e.g., cellophane or mica flakes) with 50-400 μm particles at a dosage of 25-50 ppb with high-rate pumps. A severity classification of Total may result in injection of a two-component sealant (e.g., simultaneous annular and drill-pipe squeeze). Using dynamic feedback loops, control system 100 may adjust injection parameters based on real-time borehole response (e.g., flow stabilization, pressure recovery). If, for example, injection fails, the control system 100 may recommend cement squeeze or zonal isolation packer deployment. The control system 100 may continuously compare expected versus actual loss-control performance, enabling the machine-learning model to refine threshold and future dosing based on injection efficacy. Control system 100 may also time-stamp, grade, and link each LCM action to borehole section for further analysis. Closed-loop coordination with orifice-metering and compressibility modules ensures LCM interventions maintain target ECD and Re thresholds.

Control system 100 may also optimize additive use (e.g., minimizing polymer or barite dosing) to meet regulatory standards while reducing costs, which is particularly important in top hole drilling where large fluid volumes are used. Control system 100 may also monitor LCM stocks in hoppers to automatically order LCM grades as described above.

An exemplary control sequence for top hole spud mud control is provided. The pump may be activated such that bentonite-based spud mud is circulated. Real-time sensors compare measured flow rate against expected pump output and pit volume change. The control system computes Reynolds number using flow, viscosity, and wellbore geometry. If Re falls below threshold for turbulent transport, the control system may correct turbulence by increasing the pump rate or recommending a viscosity modifier (e.g., polymer additive) to restore turbulent flow. If acoustic sensors detect gas slugs, the control system may invoke MF8/AGA8 routines to confirm gas compressibility effects. When gas influx is confirmed, the control system may engage the diverter system, issue a rig floor alert, and log the event. After stabilizing pressures and confirming well integrity, normal circulation resumes and all actions are logged for traceability.

An exemplary control sequence for intermediate section KCl-PHPA is provided. As drilling progresses from the top hole to the intermediate section, control system 100 shifts from providing spud mud to providing KCl-PHPA blend, updating rheology model parameters. Real-time viscometers and loss-circulation sensors feed data to control system, which verifies that flow regime maintains particle suspension without exceeding shear thresholds that compromise shale inhibition. If Re is too high (excessively turbulent) or fluid loss spikes, the control system may recommend either dilution or targeted HEC/PHPA concentrate addition. The control system may also sequence LCM injectors and recalibrate pump schedules to prevent formation fractures. These steps may repeat to ensure stable inhibition and controlled fluid loss throughout drilling of the intermediate section.

### Additional Exemplary Uses of an Anthropomorphic Ai Control System

While the exemplary embodiment of control system 100 as disclosed herein is described in a drilling operation context, control system 100 can be used to control an industry process. With multimodal data processing and delivery of real-time control, control system 100 can improve efficiency, reduce waste, and improve safety across a variety of industries.

In particular, control system 100 is highly adaptable to any industry managing multiphase fluid processes. Multi-phase fluids, characterized by mixtures of liquids, gases, and solids, pose challenges in flow control, phase separation, and material handling due to their complex rheology and dynamic behavior. Multimodal data processing as described herein enables seamless adaptation of control system 100 to diverse data types (e.g., chemical composition in pharmaceuticals, particle size in mining). Physics based equations and custom fluid dynamics algorithms allow control system 100 to handle non-Newtonian behavior, phase interactions, and variable conditions (e.g., pressure, temperature, shear rates). Furthermore, custom fluid dynamics algorithms may be parameterized to handle varying fluid properties, making them applicable to emulsions, slurries, or gas-liquid systems. Integration of multi-modal data (e.g., sensor readings, imaging, chemical analysis) enables control system 100 to predict phase behavior, optimize flow, and automate control, reducing human intervention. Real-time calculation of a Reynolds number prioritizes viscosity-dominated flows, which is critical for ensuring precise control in laminar or transitional regimes in processes involving slurries, emulsions, or suspensions. Real-time automation enables rapid adjustments to flow rates, additive dosing, and separation processes, minimizing downtime and material waste.

Exemplary industrial applications are provided. In the oil and gas industry, control system 100 may be used to manage multiphase flow in pipelines and separators. For example, control system 100 can optimize crude oil transport in pipelines with gas, water, and sand mixtures by monitoring flow rates and adjusting demulsifier injections to enhance phase separation, thereby minimizing emulsion-related blockages and improving throughout to reduce pipeline corrosion and maintenance costs. In chemical manufacturing, control system 100 may be used to control multiphase reactors (e.g., slurry reactors, gas-liquid reactors, etc.). For example, in polymer production, control system 100 can manage slurry reactors with polymer particles, solvents, and gases, predicts gas-liquid interactions, and optimizes catalyst dosing, thereby improving yield, reducing batch processing time and waste, and lowering production costs. In food and beverage processing, control system 100 may be used to handle emulsions, suspensions, and bas-liquid mixtures. For example, in dairy processing, control system 100 may control milk homogenization (liquid-fat-gas mixtures), analyzes particle size via imaging, and adjust pressure and flow to optimize emulsion stability, thereby reducing spoilage, enhancing product quality, and extending product shelf life. In pharmaceutical manufacturing, control system 100 may be used to manage multi-phase fluid in drug formulation and crystallization. For example, in active pharmaceutical ingredient production, control system 100 can manage suspensions of crystals in liquid solvents with gas sparging, ensure laminar flow for uniform crystal growth, and optimize solvent additives, thereby improving purity and reduce defective batches. In mining and mineral processing, control system 100 may be used to manage slurry transport and tailings. For example, in copper mining, control system 100 may manage slurry pipelines with ore particles, water, and air, prevent sedimentation, and adjust flocculant dosing, thereby reducing pump wear and lowering maintenance costs and environmental impact. In wastewater treatment, control system 100 may be used to manage multiphase fluid treatment in aeration tanks and sludge processing. For example, control system 100 may optimize aeration in wastewater tanks with liquid, gas, and solid biomass, manage gas-liquid interactions, and adjust coagulant dosing, thereby improving solids separation, reducing energy costs, and enhancing compliance with environmental regulations. In fluid transport logistics coordination, control system 100 may manage multiphase fluid logistics in shipping and storage. For example, in liquefied natural gas transport, control system 100 can monitor multiphase flows (liquid-gas mixtures) in cryogenic tanks, predict phase changes during transit, and adjust pump rates, thereby reducing boil-off losses. Control system 100 may also manage multiphase fluid logistics in oil and gas production and geothermal production.

While this disclosure has been particularly shown and described with reference to preferred embodiments, it will be understood by those skilled in the pertinent field of art that various changes in form and detail may be made therein without departing from the spirit and scope of the disclosed principles. The inventors expect skilled artisans to employ such variations as appropriate, and the inventors intend the disclosed principles to be practiced otherwise than as specifically described herein. Accordingly, this disclosure includes all modifications and equivalents of the subject matter recited in the claims appended hereto, as permitted by applicable law. Moreover, any combination of the above-described elements in all possible variations thereof is encompassed by the disclosure unless otherwise indicated herein or otherwise clearly contradicted by context.

Also, while various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the disclosed principles set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” or disclosed principles in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

Moreover, the Abstract is provided to comply with 37 C.F. R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the claims reflect, inventive subject matter lies in less than all features of a single disclosed embodiment. Thus, the following claims are hereby incorporated into the Detailed Description, with each claim standing on its own as a separate embodiment.

Any and all publications, patents, and patent applications cited in this disclosure are herein incorporated by reference as if each were specifically and individually indicated to be incorporated by reference and set forth in its entirety herein.

We claim:

1. An anthropomorphic data intelligence control system for industrial oversight comprising:
a plurality of sensors configured to collect industrial operation input data;
an artificial intelligence-enabled computing device configured to analyze input data and generate an output through anthropomorphic computing, wherein the computing device comprises:
a cognitive module performing real-time human-centric decision-making at the sensor edge; and
a controller configured to manage industrial process actuators across operational domains.

2. The system of claim 1, wherein the plurality of sensors is configured to detect one or more of light, sound, temperature, pressure, motion, chemical composition, flow, and pressure.

3. The system of claim 1, wherein the cognitive module performs predictive modeling based on asset lifecycle, vendor data, and process analytics.

4. The system of claim 1, wherein the cognitive module is configured to generate a cloud-hosted simulation digital twin synchronized with real-time sensor data.

5. The system of claim 4, wherein the cognitive module calculates a four-digit Reynolds code for classifying fluid flow regimes.

6. The system of claim 4, wherein the cognitive module generates a recommendation based on fluid flow classification and wherein the controller implements the recommendation.

7. The system of claim 1, wherein the data intelligence system operates on an edge computing infrastructure.

8. The system of claim 1, wherein edge computing is supported with cybersecurity features, edge processing, or federated machine learning.

9. The system of claim 1, further comprising a deployment topology supporting private network operations and cloud synchronization.

10. The system of claim 1, further comprising a web-based or edge accessed assistant, automated alerts, and feedback interfaces to enable operator collaboration.

11. The system of claim 1, wherein the data intelligence system is platform-agnostic and configurable for oil and gas, chemical production, utility grids, power generation, and smart building environments.

12. The system of claim 1, wherein the output includes cost analytics, equipment performance metrics, maintenance scheduling, and supply chain adaptation strategies.

13. A drilling fluid quality control system, comprising:
a plurality of sensors configured to measure borehole and drilling fluid metrics;
actuators configured to modify system operations; and
an artificial intelligence-enabled computing device configured to analyze input data and generate an output through anthropomorphic computing, wherein the computing device comprises:
a memory storing input data, predefined thresholds, and artificial intelligence programming,
a processing unit communicatively coupled to the memory and a controller, wherein the processing unit is configured to process input data and generate a recommendation using the artificial intelligence programming and the controller is configured to adjust actuator operation based on the recommendation.

14. The system of claim 13, wherein the plurality of sensors includes a gamma-ray densitometer for density measurement and an optical particle counter for solids concentration.

15. The system of claim 13, wherein the actuators comprise a chemical dosing skid and a variable-speed pump drive.

16. The system of claim 13, wherein data collected by the plurality of sensors may be filtered for noise and drift.

17. The system of claim 13, wherein the controller includes a manual override interface.

18. The system of claim 13, wherein the plurality of sensors include downhole pressure gauges and surface flowmeters.

19. The system of claim 13, wherein the predefined thresholds are updated in real-time using a machine-learning algorithm.

20. The system of claim 13, further comprising an input/output unit and a user interface configured to display real-time fluid parameters and collect user input.

21. The system of claim 13, wherein system operates on an edge computing infrastructure.

22. The system of claim 21, wherein edge computing is supported with cybersecurity features, edge processing, or federated machine learning.

23. The system of claim 13, wherein the processing unit comprises:
a data fusion module configured to aggregate data from the plurality of sensors;
a Reynolds module configured to compute, in real time, a Reynolds number, and infer fluid parameters based on the computed Reynolds number;
a fluid analysis module configured to analyze fluid flow and generate predictive analytics; and
a recommendation engine configured to generate a recommendation to optimize fluid parameters.

24. The system of claim 23, wherein the data-fusion module employs an Extended Kalman Filter to fuse sensor measurements.

25. The system of claim 23, wherein the fluid analysis module implements a model predictive controller to anticipate lithology changes.

26. The system of claim 23, wherein the fluid analysis module is configured to compare the inferred fluid parameter and solids concentration against predefined thresholds;

27. The system of claim 23, wherein the fluid analysis module is configured to generate a cloud-hosted simulation digital twin synchronized with real-time sensor data.

28. The system of claim 23, wherein the data fusion module operates at a periodicity between 1 and 5 seconds.

29. The system of claim 23, wherein the recommendation engine issues an alert when solids concentration exceeds a critical threshold.

30. The system of claim 23, further comprising a supply chain management module configured to generate supply lists, monitor consumption, and automate supply procurement.

31. A method for controlling drilling fluid quality, comprising the steps of:
acquiring real-time sensor data including flow rate, fluid density, drill-string and borehole dimensions, and solids concentration;
calculating a Reynolds number from the acquired data;
inverting the Reynolds equation to determine inferred fluid parameters;
analyzing fluid flow based on sensor data and inferred fluid parameters;
issuing commands to one or more actuators to adjust fluid properties or flow rate; and
recording the sensor data and actuator commands for iterative threshold refinement.

32. The method of claim 31, wherein calculating the Reynolds number comprises determining hydraulic diameter caliper log measurements.

33. The method of claim 31, wherein inferred fluid parameters include inferred fluid viscosity and inferred flow velocity.

34. The method of claim 31, wherein analyzing fluid flow comprises comparing the sensor data and the inferred fluid parameter and solids concentration to target values.

35. The method of claim 31, wherein issuing commands comprises injecting viscosifier when inferred viscosity falls below a lower threshold.

36. The method of claim 31, further comprising updating target values based on historical performance.

37. The method of claim 31, further comprising applying temperature correction to the inferred fluid parameters.

38. The method of claim 31, further comprising performing a fault tolerance check and reverting to manual control if a sensor fails.
